(19) United States
(12) Patent Application Publication
(10) Pub. No.: US 2021/0405407 A1
(43) Pub. Date: Dec. 30, 2021

(54) LIQUID CRYSTAL DISPLAY PANEL, LIQUID CRYSTAL DISPLAY DEVICE, AND ELECTRONIC DEVICE

(71) Applicant: WUHAN CHINA STAR OPTOELECTRONICS TECHNOLOGY CO., LTD., Wuhan, Hubei (CN)

(72) Inventors: Yuan SUN, Wuhan, Hubei (CN); Xindong MEI, Wuhan, Hubei (CN); Chao WANG, Wuhan, Hubei (CN); Guanghui LIU, Wuhan, Hubei (CN); He JIANG, Wuhan, Hubei (CN); Quan TANG, Wuhan, Hubei (CN); Zhifu LI, Wuhan, Hubei (CN)

(73) Assignee: WUHAN CHINA STAR OPTOELECTRONICS TECHNOLOGY CO., LTD., Wuhan, Hubei (CN)

(21) Appl. No.: 16/756,323

(22) PCT Filed: Jan. 3, 2020
(86) PCT No.: PCT/CN2020/070284

§ 371 Date: Apr. 15, 2020

(30) Foreign Application Priority Data
Aug. 28, 2019 (CN) 201910804735.2

(51) Int. Cl. G02F 1/1347; G02F 1/1335; G02F 1/137; G02F 1/1339; G02F 1/1343

(52) U.S. Cl. CPC G02F 1/1347; G02F 1/133528; G02F 2201/50; G02F 1/1339; G02F 1/13439; G02F 1/13756

(57) ABSTRACT

The present application provides a liquid crystal display panel, a liquid crystal display device, and an electronic device. By removing portions of a first polarizer and a second polarizer of the liquid crystal display panel that corresponds to a light-transmitting area, light can be transmitted in the light-transmitting area of the liquid crystal display panel. In addition, by setting a first liquid crystal layer in the light-transmitting area of the liquid crystal display panel to allow a portion of the liquid crystal display panel corresponding to the light-transmitting area in a display state.

### FIELD OF INVENTION

The present application relates to the field of display technologies, and in particular, to a liquid crystal display panel, a liquid crystal display device, and an electronic device.

### BACKGROUND OF INVENTION

With continuous development of display technologies, the popularity of mobile portable devices has increased. However, people propose more demands for the display visual experience of intelligent terminals. One important aspect is a full-screen visual experience. Full-screen technology is a broader definition of the design of ultra-high screen mobile portable devices in the industry. That is, the display interface of the mobile portable device is completely covered by the screen. The positions of four frames of the mobile portable device are all frameless to pursue an ultra-high screen ratio close to 100%.

At present, due to a functional demand of a front camera, it is necessary to “divide” a part of the area on the screen of a mobile portable device to provide a dedicated optical channel for the front camera. This method is so-called “irregular” dividing, and there are “bangs screen” and “water drop screen” designs and the like in the market. However, this irregular dividing design may destroy the screen integrity, and moreover, it cannot achieve a 100% screen ratio display. Traditional technologies have used a mechanical structure such as a telescopic camera to achieve full-screen display, but the display device incorporating a mechanical structure such as the telescopic camera has disadvantages of non-waterproof, short service life, and prone to damage, thereby it provides a poor user experience.

Therefore, how to achieve a full screen without destroying the integrity of the screen and without introducing a mechanical structure is an urgent problem in the art.

### Technical Problem

The purpose of the present application is to provide a liquid crystal display panel, a liquid crystal display device, and an electronic device, so as to realize a full-screen display of the liquid crystal display device and the electronic device.

### SUMMARY OF INVENTION

A liquid crystal display panel, including at least one light-transmitting area, wherein the liquid crystal display panel includes a first substrate, a second substrate, a first polarizer, and a second polarizer, the first substrate and the second substrate are oppositely disposed, the first polarizer is disposed on a surface of the first substrate away from the second substrate and a first through-hole is provided corresponding to the light-transmitting area, the second polarizer is disposed on a surface of the second substrate away from the first substrate and a second through-hole is provided corresponding to the light-transmitting area, a first liquid crystal layer is provided between a portion of the first substrate corresponding to the light-transmitting area and a portion of the second substrate corresponding to the light-transmitting area, the first liquid crystal layer is configured to enable a portion of the liquid crystal display panel corresponding to the light-transmitting area in a display state, and the first liquid crystal layer includes a plurality of first liquid crystal molecules.

In the above liquid crystal display panel, the first liquid crystal layer enables a portion of the liquid crystal display panel corresponding to the light-transmitting area in a display state under a first preset condition, the first preset condition is that a voltage difference between a portion of the first substrate corresponding to the light-transmitting area and a portion of the second substrate corresponding to the light-transmitting area is greater than or equal to a first preset threshold.

In the above liquid crystal display panel, the plurality of the first liquid crystal molecules in the first liquid crystal layer enables a portion of the liquid crystal display panel corresponding to the light-transmitting area in a transparent state or a semi-transparent state under a second preset condition, the second preset condition is that a voltage difference between a portion of the first substrate corresponding to the light-transmitting area and a portion of the second substrate corresponding to the light-transmitting area is less than the first preset threshold.

In the above liquid crystal display panel, the first liquid crystal molecule is a phase liquid crystal.

In the above liquid crystal display panel, the phase liquid crystal is selected from at least one of a twisted nematic phase liquid crystal and a polymer-stabilized blue phase liquid crystal.

In the above liquid crystal display panel, the first liquid crystal molecule is a scattering-type liquid crystal.

In the above liquid crystal display panel, the liquid crystal display panel further includes a main display area, the main display area is positioned at a periphery of the light-transmitting area, a second liquid crystal layer is provided between a portion of the first substrate corresponding to the main display area and a portion of the second substrate corresponding to the main display area, the second liquid crystal layer includes a plurality of second liquid crystal molecules.

In the above liquid crystal display panel, the first liquid crystal molecule and the second liquid crystal molecule are the same.

In the above liquid crystal display panel, the first liquid crystal molecule and the second liquid crystal molecule are both phase liquid crystal.

In the above liquid crystal display panel, the first liquid crystal molecule and the second liquid crystal molecule are different.

In the above liquid crystal display panel, the liquid crystal display panel further includes an isolation portion, the isolation portion is disposed between the first liquid crystal layer and the second liquid crystal layer to isolate the first liquid crystal layer and the second liquid crystal layer, the isolation portion is positioned between the first substrate and the second substrate and is positioned at the periphery of the light-transmitting area.

In the above liquid crystal display panel, the isolation portion is an annular sealant.

In the above liquid crystal display panel, the first liquid crystal molecules are scattering-type liquid crystals, and the second liquid crystal molecules are selected from one of thermotropic liquid crystals, lyotropic liquid crystals, and phase liquid crystals.

In the above liquid crystal display panel, a thickness of the first liquid crystal layer is greater than a thickness of the second liquid crystal layer.

In the above liquid crystal display panel, the liquid crystal display panel further includes a transparent protective layer formed on a surface of the first substrate toward the second substrate, a thickness of a portion of the first substrate corresponding to the light-transmitting area is less than a thickness of a portion of the first substrate corresponding to the main display area, and/or a thickness of a portion of the transparent protective layer corresponding to the light-transmitting area is less than a thickness of a portion of the transparent protective layer corresponding to the main display area.

In the above liquid crystal display panel, the liquid crystal display panel further includes a transparent driving circuit disposed in the light-transmitting area, the transparent driving circuit is configured to drive the plurality of the first liquid crystal molecule in the first liquid crystal layer to deflect.

In the above liquid crystal display panel, the transparent driving circuit includes a first transparent electrode and a second transparent electrode, the first transparent electrode is disposed on a surface of the first substrate toward the second substrate and is formed on an entirety of the light-transmitting area, and the second transparent electrode is disposed on a surface of the second substrate toward the first substrate and is formed on an entirety of the light-transmitting area.

In the above liquid crystal display panel, the liquid crystal display panel further includes a second pixel driving circuit layer disposed on the second substrate and positioned at a periphery of the light-transmitting area, and the first transparent electrode and the second pixel driving circuit layer are electrically connected by a conductive portion.

A liquid crystal display device, including the liquid crystal display panel described above and a backlight assembly, wherein the backlight assembly is positioned at a side of the liquid crystal display panel where the second substrate is positioned, and the backlight assembly corresponding to the light-transmitting area of the liquid crystal display panel is provided with a third through-hole.

An electronic device, including the liquid crystal display device described above and a photosensitive unit, wherein the photosensitive unit is disposed opposite to a side of the liquid crystal display device where light is emitted and is disposed corresponding to the light-transmitting area.

### Beneficial Effect

The present application provides a liquid crystal display panel, a liquid crystal display device, and an electronic device. By removing portions of a first polarizer and a second polarizer of the liquid crystal display panel that corresponds to a light-transmitting area, light can be transmitted in the light-transmitting area of the liquid crystal display panel. In addition, by setting a first liquid crystal layer in the light-transmitting area of the liquid crystal display panel to allow a portion of the liquid crystal display panel corresponding to the light-transmitting area in a display state. This enables the liquid crystal display panel of the light-transmitting area not only has a light-transmitting function but also has a display function. The liquid crystal display device can realize a full-screen display, and while the electronic device realizes the full-screen display, the photosensitive units receive optical signals.

### DESCRIPTION OF DRAWINGS

FIG. 1A is a schematic plan view of a display screen of an electronic device when a photosensitive unit is in a working state.

FIG. 1B is a schematic plan view of a display screen of an electronic device when a photosensitive unit is in an off state.

FIG. 2 is a schematic exploded view of an electronic device according to a first embodiment of the present application.

FIG. 3A is a first schematic cross-sectional view of the electronic device shown in FIG. 2.

FIG. 3B is a schematic diagram of a first liquid crystal layer under different conditions.

FIG. 3C is a second schematic cross-sectional view of the electronic device shown in FIG. 2.

FIG. 3D is a third schematic cross-sectional view of the electronic device shown in FIG. 2.

FIG. 4A is a fourth schematic cross-sectional view of the electronic device shown in FIG. 2.

FIG. 4B is a fifth schematic cross-sectional view of the electronic device shown in FIG. 2.

FIG. 5 is an exploded schematic view of an electronic device according to a second embodiment of the present application.

FIG. 6A is a first schematic cross-sectional view of the electronic device shown in FIG. 5.

FIG. 6B is a second schematic cross-sectional view of the electronic device shown in FIG. 5.

FIG. 6C is a third schematic cross-sectional view of the electronic device shown in FIG. 5.

FIG. 6D is a fourth schematic cross-sectional view of the electronic device shown in FIG. 5.

FIG. 7A is a fifth schematic cross-sectional view of the electronic device shown in FIG. 5.

FIG. 7B is a sixth schematic cross-sectional view of the electronic device shown in FIG. 5.

### REFERENCE NUMERALS

1000 electronic device; 100 liquid crystal display device; 200 photosensitive unit; 100a first display area; 100b second display area; 10 liquid crystal display panel; 10a light-transmitting area; 10b main display area; 20 backlight assembly; 201 first backlight assembly; 2011 first light source; 2012 backlight plate; 2012a first surface; 2012b fourth through-hole; 202 second backlight assembly; 2021 second light source; 2022 light-guiding ring; 2022a first plane; 2022b second plane; 2022c indented arc surface; 20a third through-hole; 101 liquid crystal cell; 102 first polarizer; 102a first through-hole; 103 second polarizer; 103a second through-hole; 1011 first liquid crystal layer; 1012 second liquid crystal layer; 1013 first substrate; 1014 second substrate; 1015 pixel driving circuit layer; 10151 first pixel driving circuit layer; 10152 second pixel driving circuit layer; 1016 common electrode; 10161 first common electrode; 10162 second common electrode; 1017 first pixel electrode; 1018 second pixel electrode; 1019 color film layer; 1020 transparent protective layer; 1021 peripheral sealant; 1023 isolation portion; 10241 first transparent electrode; 10242 second transparent electrode; 1025 conductive microsphere; 1026 conductive layer; 1027 conductive sealant; 23 light-shielding portion.

### DETAILED DESCRIPTION OF PREFERRED EMBODIMENTS

The technical solutions in the embodiments of the present application will be clearly and completely described below with reference to the accompanying drawings in the embodiments of the present application. Obviously, the embodiments are only a part of the embodiments of the present application, but not all the embodiments. Based on the embodiments in the present application, all other embodiments obtained by those skilled in the art without creative effort fall into the protection scope of the present application.

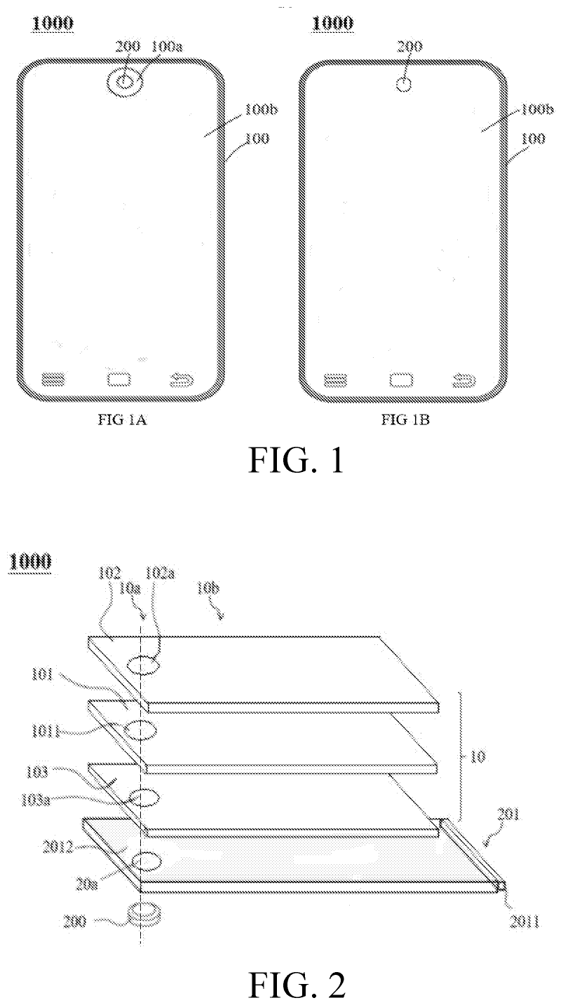

Please refer to FIG. 1A and FIG. 1B. FIG. 1A is a schematic plan view of a display screen of an electronic device when a photosensitive unit is in a working state, and FIG. 1B is a schematic plan view of a display screen of an electronic device when a photosensitive unit is in an off state.

The electronic device 1000 includes a liquid crystal display device 100 and a photosensitive unit 200. The liquid crystal display device 100 has at least a first display area 100a and a second display area 100b. The second display area 100b is disposed on a periphery of the first display area 100a. The second display area 100b is larger than the first display area 100a. The first display area 100a is used for displaying an image and transmitting light so that the photosensitive unit 200 can receive a light signal, that is, the first display area 100a can be switched between a display state and a light-transmitting state. The second display area 100b is used for display. The photosensitive unit 200 is disposed opposite to a side of the liquid crystal display device 100 where light is emitted and is disposed corresponding to the first display area 100a. An orthographic projection of the photosensitive unit 200 on the liquid crystal display device 100 is smaller than the size of the first display area 100a. The photosensitive unit 200 can be one of a camera, a light sensor, an optical fingerprint recognition device, and an optical touch component, or a combination thereof.

When the photosensitive unit 200 is in the working state and the electronic device 1000 is in the display state, the second display area 100b displays an image, and the first display area 100a does not display an image and in a light-transmitting state. The light signal incident from the outside of the electronic device 1000 to the first display area 100a passes through the liquid crystal display device 100 and is received by the photosensitive unit 200. When the photosensitive unit 200 is in the off state and the electronic device 1000 is in the display state, the second display area 100b and the first display area 100a both display images, and the liquid crystal display device 100 realizes full-screen display so that the electronic device 1000 achieves full-screen display. The liquid crystal display device 100 is provided with at least a first display area 100a corresponding to the photosensitive unit 200 so that the liquid crystal display device 100 and the electronic device 1000 realize full-screen display and the photosensitive unit 200 of the electronic device 1000 can work simultaneously. Therefore, electronic device1000 has additional functions.

It should be noted that the first display area 100a of the liquid crystal display device 100 is defined by a light-transmitting area 10a of the liquid crystal display panel 10 hereinafter. The first display area 100a of the liquid crystal display device 100 corresponds to the light-transmitting area 10a of the liquid crystal display panel 10 in a one-to-one correspondence and they completely coincide with each other. The second display area 100b of the liquid crystal display device is defined by the main display area 10b of the liquid crystal display panel 10. The second display area 100b of the liquid crystal display device and the main display area 10b of the liquid crystal display panel 10 completely coincide with each other.

Please refer to FIG. 2, which is a schematic exploded view of an electronic device according to a first embodiment of the present application. The electronic device 1000 includes a liquid crystal display device 100 and a photosensitive unit 200. The liquid crystal display device 100 includes a liquid crystal display panel 10 and a first backlight assembly 201. The liquid crystal display panel 10 includes a liquid crystal cell 101, a first polarizer 102, and a second polarizer 103. The first polarizer 102 is disposed on a light-emitting side of the liquid crystal cell 101, and the second polarizer 103 is disposed on a light incident side of the liquid crystal cell 101. The first backlight assembly 201 is disposed on a side of the second polarizer 103 away from the liquid crystal cell 101. The photosensitive unit 200 is disposed on a side of the first backlight assembly 201 away from the liquid crystal display panel 10.

The liquid crystal display panel 10 has at least one light-transmitting area 10a, that is, the light-transmitting area 10a may be one or more. Specifically, the liquid crystal display panel 10 has one light-transmitting area 10a. The liquid crystal display panel 10 further includes a main display area 10b. The main display area 10b is positioned at a periphery of the light-transmitting area 10a. A portion of the liquid crystal cell 101 corresponding to the light-transmitting area 10 a is provided with a first liquid crystal layer 1011. A first polarizer 102 is provided with a first through-hole 102a corresponding to the light-transmitting area 10a. A second polarizer 103 is provided with a second through-hole 103a corresponding to the light-transmitting area 10a.

The first backlight assembly 201 is used for the light-transmitting area 10a and the main display area 10b when they display images together, it serves as the same backlight source of the light-transmitting area 10a and the main display area 10b. The first backlight assembly 201 is provided with a third through-hole 20a corresponding to the light-transmitting area 10a of the liquid crystal display panel 10. The first backlight assembly 201 includes a backlight plate 2012 and a first light source 2011. The first light source 2011 is disposed on a side of the backlight plate 2012. The backlight plate 2012 is provided with a third through-hole 20a corresponding to the light-transmitting area 10a. The first light source 2011 is a white light-emitting diode (LED).

When the photosensitive unit 200 is turned off, the light emitted by the first light source 2011 is incident on the backlight plate 2012. The backlight plate 2012 processes the light emitted by the first light source 2011 to emit surface light. A part of the surface light is incident on the light-transmitting area 10a of the liquid crystal display panel 10, passes through the second through-hole 103a of the second polarizer 103, and reaches the liquid crystal cell 101. After being processed by the first liquid crystal layer 1011 in the liquid crystal cell 101, it finally passes through the first through-hole 102a of the first polarizer 102, thereby enables the liquid crystal display panel 10 of the light-transmitting area 10a to display images. When the photosensitive unit 200 is turned on, external light passes through the first through-hole 102a of the first polarizer 102 and passes through the transparent first liquid crystal layer 1011 of the liquid crystal cell 101, and then passes through the second through-hole 103a of the second polarizer 103 and is received by the photosensitive unit 200. It should be noted that the state of the first liquid crystal layer 1011 when the photosensitive unit 200 is turned off and the state of the first liquid crystal layer 1011 when the photosensitive unit 200 is turned on are different. Specifically, the first liquid crystal layer 1011 is non-transparent when the photosensitive unit 200 is in an off state and the light-transmitting area 10a is required to display images. The first liquid crystal layer 1011 is transparent when the photosensitive unit 200 is in a turn-on state.

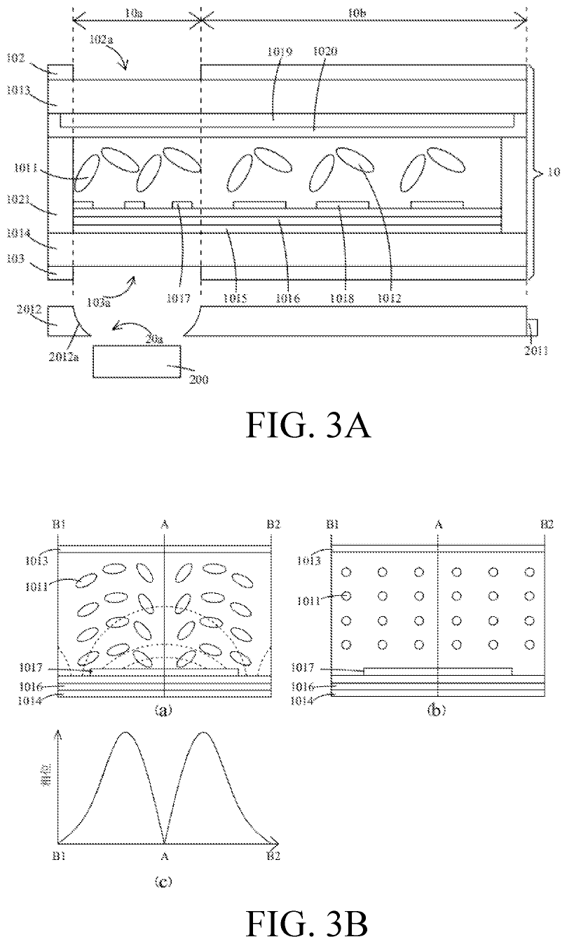

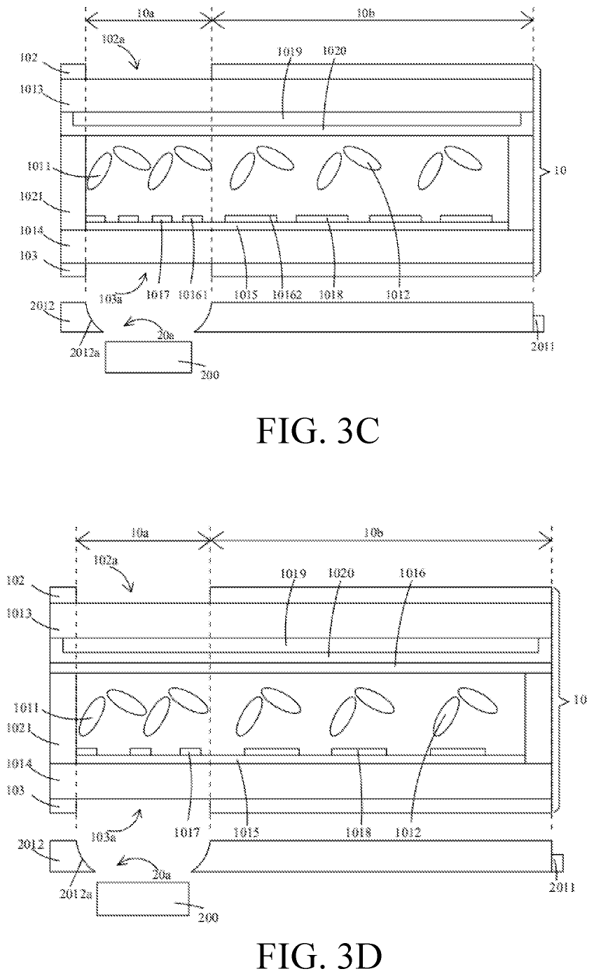

Please refer to FIG. 3A, which is a first schematic cross-sectional view of the electronic device shown in FIG. 2. The electronic device 1000 includes a liquid crystal display device 100 and a photosensitive unit 200. The liquid crystal display device 100 is a fringe field switching (FFS) type liquid crystal display device. The liquid crystal display device 100 includes a liquid crystal display panel 10 and a first backlight assembly 201. The liquid crystal display panel 10 has at least one light-transmitting area 10a, and the liquid crystal display panel 10 further includes a main display area 10b. The main display area 10b is positioned at a periphery of the at least one light-transmitting area 10a. The main display area 10b is used to display images, and the light-transmitting area 10a is used for switching between the image display function and the light transmission function.

The liquid crystal display panel 10 includes a first substrate 1013, a second substrate 1014, a first polarizer 102, a second polarizer 103, a first liquid crystal layer 1011, a second liquid crystal layer 1012, a pixel driving circuit layer 1015, a common electrode 1016, and a first pixel electrode 1017, a second pixel electrode 1018, a color film layer 1019, a transparent protective layer 1020, and a peripheral sealant 1021. The first substrate 1013 and the second substrate 1014 are opposed to each other. The first substrate 1013 and the second substrate 1014 are both transparent glass substrates.

The first polarizer 102 is disposed on a surface of the first substrate 1013 away from the second substrate 1014 and is provided with a first through-hole 102a corresponding to the light-transmitting area 10a. The second polarizer 103 is disposed on a surface of the second substrate 1014 away from the first substrate 1013 and is provided with a second through-hole 103a corresponding to the light-transmitting area 10a. The first polarizer 102 and the second polarizer 103 deflect light in different directions, both of them cooperate with the second liquid crystal layer 1012 to realize the change of brightness of the display screen in the main display area 10b. A first through-hole 102a is provided on the first polarizer 102 and a second through-hole 103a is provided on the second polarizer 103, so as to ensure that the light-transmitting area 10a has a light-transmitting capability.

A first liquid crystal layer 1011 is disposed between a portion of the first substrate 1013 corresponding to the light-transmitting area 10a and a portion of the second substrate 1014 corresponding to the light-transmitting area 10a. The first liquid crystal layer 1011 includes a plurality of first liquid crystal molecules. The first liquid crystal layer 1011 is used to make a portion of the liquid crystal display panel 10 corresponding to the light-transmitting area 10a in a display state.

A second liquid crystal layer 1012 is disposed between a portion of the first substrate 1013 corresponding to the main display area 10b and a portion of the second substrate 1014 corresponding to the main display area 10b. The second liquid crystal layer 1012 includes a plurality of second liquid crystal molecules.

The first liquid crystal molecule and the second liquid crystal molecule are the same. Specifically, the first liquid crystal molecule and the second liquid crystal molecule are both phase liquid crystal. The phase liquid crystal is selected from at least one of a twisted nematic phase liquid crystal and a polymer-stabilized blue phase liquid crystal. It should be understood that the first liquid crystal molecule can also be other liquid crystal material that enables the light-transmitting area 10a to perform display after removing the polarizer. As shown in FIG. 3B is a schematic diagram of the first liquid crystal layer under different conditions, wherein FIG. (a) is a schematic diagram of a first liquid crystal layer in the light-transmitting area under a first preset condition, FIG. (b) is a schematic diagram when the voltage difference between the pixel electrode and the common electrode of the first liquid crystal layer in the light-transmitting area is zero, and FIG. (c) is a schematic diagram of the phase distribution at different positions in FIG. (a). The first liquid crystal layer 1011 enables a portion of the liquid crystal display panel 10 corresponding to the light-transmitting area 10a in a display state under a first preset condition. The first preset condition is that a voltage difference between a portion of the first substrate 1013 corresponding to the light-transmitting area 10a and a portion of the second substrate 1014 corresponding to the light-transmitting area 10a is greater than or equal to a first preset threshold. Specifically, as shown in FIG. (a), the voltage difference between the common electrode 1016 and the pixel electrode 1017 of the light-transmitting area 10a has a component electric field parallel to the first substrate 1013 and the second substrate 1014 so that a plurality of first liquid crystal molecules respond in a direction parallel to the surfaces of the first substrate 1013 and the second substrate 1014. As shown in FIG. (C), a plurality of first liquid crystal molecules is driven in response to a component electric field between the first pixel electrode 1017 and the common electrode 1016, so that the refractive indices corresponding to the first liquid crystal layer 1011 at different positions are periodically distributed. The light incident from the first backlight assembly 201 to the first liquid crystal layer 1011 generates phase differences at different positions due to the periodic distribution of the refractive index of the first liquid crystal layer, thereby when the light passing through the first liquid crystal layer 1011 is superimposed at different emit angles, the light rays are superimposed or cancels out each other, and finally, a diffraction pattern is generated, and a fog is generated to display an image.

The plurality of the first liquid crystal molecules in the first liquid crystal layer 1011 enables a portion of the liquid crystal display panel 10 corresponding to the light-transmitting area 10a in a transparent state or a semi-transparent state under a second preset condition, the second preset condition is that a voltage difference between a portion of the first substrate 1013 corresponding to the light-transmitting area 10a and a portion of the second substrate 1014 corresponding to the light-transmitting area 10a is less than the first preset threshold. Specifically, as shown in FIG. (b) and FIG. 2, the second preset condition is that the voltage difference between the common electrode 1016 and the first pixel electrode 1017 in the light-transmitting area 10a is zero, and the first liquid crystal layer 1011 is in a transparent state. External light sequentially passes through the first through-hole 102a, the first substrate 1013, the color film layer 1019, the transparent protective layer 1020, the transparent first liquid crystal layer 1011, the second substrate 1014, and the film layers on the second substrate 1014, it then passes through the third through-hole 20a and reaches the photosensitive unit 200.

In the main display area 10b, a plurality of second liquid crystal molecules is phase liquid crystals. The plurality of second liquid crystal molecules realizes image display under a third preset condition. The third preset condition is that a voltage difference between a portion of the first substrate 1013 corresponding to the main display area 10b and a portion of the second substrate 1014 corresponding to the main display area 10b is greater than or equal to a third preset threshold. In addition, the first polarizer 102 and the second polarizer 103 are used to selectively transmit light to realize the screen display of the main display area 10b. A voltage difference greater than or equal to the third preset threshold is generated by applying a voltage to the common electrode 1016 and the second pixel electrode 1018 of the main display area 10b.

It should be noted that, when the first liquid crystal molecules and the second liquid crystal molecules are phase liquid crystals, the principle of displaying images in the light-transmitting area 10a is different from that in the main display area 10b. In the light-transmitting area 10a, the first polarizer 102 and the second polarizer 103 are removed, it completely utilizes a plurality of first liquid crystal molecules to enable the light emitted from the first backlight assembly 201 phase-diffracted under a first preset condition to realize image display. However, the main display area 10b utilizes an effect of the second liquid crystal molecules (phase liquid crystal) on light in a specific voltage range and cooperates with the first polarizer 102 and the second polarizer 103 to selectively transmit light to realize image display. When the second liquid crystal molecules (phase liquid crystal) in the main display area 10b process the light emitted from the first backlight assembly 201, light diffraction will also occur, but the image display effect of the main display area 10b will not be affected.

The first backlight assembly 201 includes a backlight plate 2012 and a first light source 2011. The backlight plate 2012 is a light guide plate. The backlight plate 2012 is positioned at a side of the liquid crystal display panel 10 where the second substrate 1014 is positioned. The backlight plate 2012 corresponding to the light-transmitting area 10a of the liquid crystal display panel 10 is provided with a third through-hole 20a. The third through-hole 20a is formed by being surrounded by the first surface 2012a, and the first surface 2012a is an indented arc surface to improve light transmittance on the first surface 2012a. As described above, the first light source 2011 is disposed on a side of the backlight plate 2012. The first light source 2011 is a white LED. The light emitted by the first light source 2011 is repeatedly refracted and reflected in the backlight plate 2012 to be mixed, a part of the light is refracted from the first surface 2012a so that the light is incident on the light-transmitting area 10a, and the light entering the light-transmitting area 10a is processed by the first liquid crystal layer 1011 and the color film layer 1019 under the first preset condition to display color screen. For the main display area 10b, the light emitted by the backlight plate 2012 is sequentially incident on the second polarizer 103, the second liquid crystal layer 1012 under the third preset condition, the first polarizer 102, and the color film layer 1019 of the main display area 10b to display color screen.

The pixel driving circuit layer 1015 includes a plurality of pixel driving circuits. The plurality of pixel driving circuits in the pixel driving circuit layer 1015 is used as switches to control voltages applied to the first liquid crystal layer 1011 in the light-transmitting area 10a and the second liquid crystal layer 1012 in the main display area 10b, to control the switching between the display state and the light transmission state of the light-transmitting area 10a and the display state and the non-display state of the main display area 10b. Since the size of each pixel driving circuit is small, it does not significantly reduce the transparency of the light-transmitting area 10a. The pixel driving circuit layer 1015 is disposed on a surface of the second substrate 1014 toward the first substrate 1013.

The common electrode 1016, the first pixel electrode 1017, and the second pixel electrode 1018 are all disposed on the second substrate 1014. The common electrode 1016 is formed on a surface of the second substrate 1014 toward the first substrate 1013 and is formed on the light-transmitting area 10a and the main display area 10b. The first pixel electrode 1017 is formed on a side of the common electrode 1016 away from the second substrate 1014 and is positioned in the light-transmitting area 10a. The second pixel electrode 1018 is formed on a side of the common electrode away from the second substrate 1014 and is positioned in the main display area 10b. Specifically, the common electrode 1016 is disposed on a surface of the pixel driving circuit layer 1015 away from the second substrate 1014. The common electrode 1016 is an entire transparent electrode. The material for preparing the entire transparent electrode is one of indium zinc oxide and indium tin oxide. An insulating layer is provided between the first pixel electrode 1017 and the second pixel electrode 1018 and the common electrode 1016. The first pixel electrode 1017 is disposed on the insulating layer of the light-transmitting area 10a, and the second pixel electrode 1018 is disposed on the insulating layer of the main display area 10b. Both the first pixel electrode 1017 and the second pixel electrode 1018 are block-shaped transparent electrodes. Because the display principles of the light-transmitting area 10a and the main display area 10b are different, when the first liquid crystal molecules and the second liquid crystal molecules are phase liquid crystals, the design of the first pixel electrode 1017 and the second pixel electrode 1018 are also different. The first pixel electrode 1017 is made of indium tin oxide or indium zinc oxide. The second pixel electrode 1018 is made of indium tin oxide or indium zinc oxide.

The color film layer 1019 includes a plurality of black matrix and a color photoresist. The black matrix is used for shading, and the color photoresist is used for filtering light to achieve color display. The color photoresists include red photoresist, green photoresist, and blue photoresist. A red photoresist, a green photoresist, and a blue photoresist constitute a repeating unit, and a plurality of repeating unit arrays are arranged on the first substrate 1013. A black matrix is disposed between two adjacent photoresists (for example, a red photoresist and a green photoresist). The color film layer 1019 is disposed on a surface of the first substrate 1013 toward the second substrate 1014 and covers at least one light-transmitting area 10a and the main display area 10b. That is, the color film layer 1019 is disposed on the light-transmitting area 10a and the main display area 10b. The color film layer 1019 is arranged in such a manner that the light-transmitting area 10a can utilize the first backlight assembly 201 as a backlight light source, and no light source needs to be separately provided for the light-transmitting area. However, the arrangement of the color film layer 1019 also reduces the light transmittance of the light-transmitting area 10a, which is disadvantageous to the lighting effect of the photosensitive unit 200 provided corresponding to the display light-transmitting area 10a.

A transparent protective layer 1020 is formed on a surface of the first substrate 1013 toward the second substrate 1014. Specifically, the transparent protective layer 1020 covers the first substrate 1013 and the color film layer 1019, and is used to protect the color film layer 1019 and make the surface of the first substrate 1013 on which the color film layer 1019 is formed more flat, improve the alignment of the liquid crystal, and ensure the deflection of the liquid crystals. The transparent protective layer 1020 is made of an optically transparent organic material.

A peripheral sealant 1021 is used to connect the first substrate 1013 and the second substrate 1014 to form the liquid crystal cell 101. The peripheral sealant 1021 is disposed between the first substrate 1013 and the second substrate 1014. The peripheral sealant 1021 is an ultraviolet curing adhesive.

It should be noted that since the first liquid crystal layer 1011 and the second liquid crystal layer 1012 are phase liquid crystals, there is no isolation layer between the first liquid crystal layer 1011 and the second liquid crystal layer 1012 so that there is no obvious dividing line between the light-transmitting area 10a and the main display area 10b. It is beneficial to improve the overall display effect of the electronic device 1000.

Please refer to FIG. 3C, which is a second cross-sectional view of the electronic device shown in FIG. 2. The liquid crystal display device of the electronic device shown in FIG. 3C is an in-plane switching (IPS) type liquid crystal display device. The difference from the liquid crystal display device 100 shown in FIG. 3A is that the common electrode includes a first common electrode 10161 and a second common electrode 10162. The first common electrode 10161 is disposed in the light-transmitting area 10a and is disposed on the same layer as the first pixel electrode 1017. The second common electrode 10162 is disposed in the main display area 10b and is disposed on the same layer and spaced from the second pixel electrode 1018.

In the light-transmitting area 10a, the first liquid crystal layer 1011 is controlled by controlling the voltage difference between the first common electrode 10161 and the first pixel electrode 1017 to switch the electronic device 1000 between a display state and a transparent/translucent state. In the light-transmitting area 10a, the first liquid crystal layer 1011 is controlled by controlling a voltage difference between the first common electrode 10161 and the first pixel electrode 1017, so that the electronic device 1000 can be switched between a display state and a transparent state/translucent state. By controlling the voltage difference between the second common electrode 10162 and the second pixel electrode 1018, and cooperating with the selective transmission of light by the first polarizer 102 and the second polarizer 103, the screen display of the main display area 10b of the electronic device 1000 is realized.

It should be noted that the first liquid crystal molecules are deflected by the horizontal electric field generated by the voltage difference between the first common electrode 10161 and the first pixel electrode 1017, thereby a phase difference is generated between the light emitted from the first backlight assembly 201 to display a color screen. The second liquid crystal molecules are deflected by the horizontal electric field generated by the voltage difference between the second common electrode 10162 and the second pixel electrode 1018 and cooperate with the second polarizer 103 and the first polarizer 102 to selectively transmit light to realize the image display of the main display area, including the light and dark changes of the image. Both the first liquid crystal molecules and the second liquid crystal molecules are phase liquid crystals.

Please refer to FIG. 3D, which is a third cross-sectional view of the electronic device shown in FIG. 2. The liquid crystal display device of the electronic device shown in FIG. 3D is a twisted nematic (TN) or a vertical alignment (VA) type liquid crystal display device. The liquid crystal display device shown in FIG. 3D is different from the liquid crystal display device shown in FIG. 3A in that the common electrode 1016 is disposed on a surface of the transparent protective layer 1020 away from the first substrate 1013. The common electrode in the light-transmitting area 10a forms a vertical electric field with the first pixel electrode 1017 to control the first liquid crystal layer 1011 in the light-transmitting area 10a so that the light-transmitting area 10a can switch between display and light transmission. The common electrode 1016 of the main display area 10b forms a vertical electric field with the second pixel electrode 1018 and cooperates with the selective light transmission effect of the first polarizer 102 and the second polarizer 103 to realize display in the main display area 10b. Both the first liquid crystal molecules and the second liquid crystal molecules are phase liquid crystals.

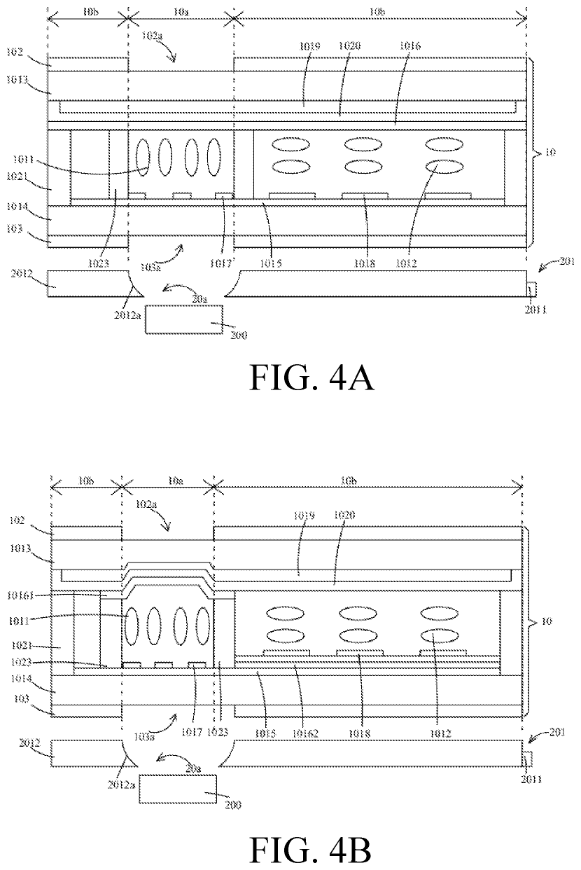

Please refer to FIG. 4A, which is a fourth schematic cross-sectional view of the electronic device shown in FIG. 2. The electronic device shown in FIG. 4A is basically similar to the electronic device shown in FIG. 3D. The difference is that the first liquid crystal molecule and the second liquid crystal molecule are different types. The pixel driving circuit layer 1015 of the light-transmitting area 10a serves as the pixel driving circuit of the light-transmitting area 10a and controls the voltage difference between the first pixel electrode 1017 and the common electrode 1016 of the light-transmitting area 10a. The pixel driving circuit layer 1015 of the main display area 10b serves as the pixel driving circuit of the main display area 10b and controls the voltage difference between the second pixel electrode 1018 and the common electrode 1016 of the main display area 10b.

The first liquid crystal molecules are scattering-type liquid crystals. The second liquid crystal molecules are selected from one of thermotropic liquid crystals, lyotropic liquid crystals, and phase liquid crystals. Specifically, the first liquid crystal molecules are scattering-type liquid crystals, and the second liquid crystal molecules are thermotropic liquid crystals; alternatively, the first liquid crystal molecules are scattering-type liquid crystals, and the second liquid crystal molecules are lyotropic liquid crystals; alternatively, the first liquid crystal molecules are scattering-type liquid crystals, and the second liquid crystal molecules are phase liquid crystals. The scattering-type liquid crystals include liquid crystal molecules and network polymers. The second liquid crystal molecules can be biphenyl liquid crystals, phenylcyclohexane liquid crystals, or ester liquid crystals. The second liquid crystal molecules can be one based on twisted nematic phase liquid crystals or polymer-stabilized blue phase liquid crystals.

When the first liquid crystal molecule is a scattering-type liquid crystal, the liquid crystal molecule and the network polymer constituting the scattering-type liquid crystal have the same anisotropic dielectric coefficient. The first preset condition is that a voltage difference between a portion of the first substrate 1013 corresponding to the light-transmitting area 10a and a portion of the second substrate 1014 corresponding to the light-transmitting area 10a is greater than or equal to a first preset threshold. Because the liquid crystal molecules constituting the scattering-type liquid crystals rotate under a vertical electric field generated by a voltage difference greater than or equal to the first preset threshold, their directions are aligned along a vertical direction, and the anisotropy characteristic of the dielectric constant of the liquid crystal molecules constituting the scattering-type liquid crystal is changed. Therefore, the refractive index difference between the liquid crystal molecules and the polymer constituting the scattering-type liquid crystal causes light to be scattered, and the light-transmitting area 10a of the liquid crystal display panel 10 exhibits a fog state for image display.

The first liquid crystal molecules in the first liquid crystal layer 1011 enable the portion of the liquid crystal display panel 10 corresponding to the light-transmitting area 10a in a transparent state or a semi-transparent state under a second preset condition. The second preset condition is that a voltage difference between a portion of the first substrate 1013 corresponding to the light-transmitting area 10a and a portion of the second substrate 1014 corresponding to the light-transmitting area 10a is less than the first preset threshold. Because when the applied voltage is less than the second threshold voltage, the liquid crystal molecules constituting the scattering-type liquid crystals are aligned horizontally, and there is no refractive index difference between the liquid crystal molecules and the network polymers constituting the scattering-type liquid crystal. When the light emitted by the first backlight assembly 201 passes through the first liquid crystal layer 1011 of a transparent state, the portion of the liquid crystal display panel 10 corresponding to the light-transmitting area 10a is in a semi-transparent state because of an effect of the color film layer 1019, and the transmissivity of the liquid crystal display panel 10 in the semi-transparent area 10a of the semi-transparent state is greater than 50%. It should be noted that the light transmittance of the liquid crystal display panel 10 in the light-transmitting 10a of the transparent state is greater than 90%.

For the main display area 10b, the second liquid crystal molecule can be one of lyotropic liquid crystals, thermotropic crystal liquid crystals, and phase liquid crystals. The second liquid crystal molecules are deflected under the third preset condition, and the light emitted by the first backlight assembly 201 is processed by the first polarizer 102 and the second polarizer 103 to realize an image display of the main display area 10b. The third preset condition is that a voltage between a portion of the first substrate 1013 corresponding to the main display area 10b and a portion of the second substrate 1014 corresponding to the main display area 10b has a voltage greater than or equal to a third preset threshold. The voltage greater than or equal to the third threshold is generated by applying a voltage to the second pixel electrode 1018 and the common electrode 1016 of the main display area 10b.

The liquid crystal display panel 10 further includes a isolation portion 1023, which is disposed between the first liquid crystal layer 1011 and the second liquid crystal layer 1012 to isolate the first liquid crystal layer 1011 and the second liquid crystal layer 1012. The isolation portion 1023 is positioned between the first substrate 1013 and the second substrate 1014 and is positioned at a periphery of the light-transmitting area 10a. The isolation portion 1023 is an annular sealant. When the isolation portion 1023 is an annular sealant, a width of the isolation portion 1023 is smaller than that of the peripheral sealant 1021 to weaken the boundary between the light-transmitting area 10a and the main display area 10b and improve the display effect of the electronic device 1000.

When the light-transmitting area 10a is away from any one end of the electronic device 1000, the isolation portion 1023 is an independent annular sealant. The light-transmitting area 10a is disposed close an edge of one end of the electronic device 1000, and the isolation portion 1023 may coincide with a part of the peripheral sealant 1021

When the first liquid crystal molecule is a scattering-type liquid crystal, the liquid crystal display panel 10 includes a first pixel electrode 1017 and a common electrode 1016, and the first pixel electrode 1017 and the common electrode 1016 of the light-transmitting area 10a form a vertical electric field to drive the first liquid crystal layer. The first pixel electrode 1017 is disposed on a surface of the second substrate 1014 close to the first substrate 1013 and is positioned in the light-transmitting area 10a, and the common electrode 1016 is disposed on a surface of the first substrate 1013 close to the second substrate 1014 and is formed at least in the light-transmitting area 10a. Specifically, the common electrode 1016 is formed on a surface of the transparent protective layer 1020 close to the second substrate 1014, and the first pixel electrode 1017 is formed on a surface of the pixel driving circuit layer 1015 away from the second substrate 1014 and is formed on the light-transmitting area 10a.

Please refer to FIG. 4B, which is a fifth cross-sectional view of the electronic device shown in FIG. 2. The electron device shown in FIG. 4B is basically similar to the electronic device shown in FIG. 4A, except that the common electrode 1016 includes a first common electrode 10161 and a second common electrode 10162. The first common electrode 10161 is disposed on a surface of the transparent protective layer 1020 close to the second substrate 1014, a part of the first common electrode 10161 is positioned in the light-transmitting area 10a, and the first common electrode 10161 is disposed opposite to the first pixel electrode 1017. The second common electrode 10162 is disposed in the main display area 10b and covers the pixel driving circuit layer 1015 of the main display area 10b. The second pixel electrode 1018 is disposed above the second common electrode 10162.

The first liquid crystal molecules are different from the second liquid crystal molecules. The first liquid crystal molecule are scattering-type liquid crystals, and the second liquid crystal molecule are one of lyotropic liquid crystals, thermotropic liquid crystals, and phase liquid crystals. In the light-transmitting area 10a, a voltage difference between the first pixel electrode 1017 and the first common electrode 10161 generates a vertical electric field, that is, the light-transmitting area 10a uses the vertical electric field to drive the first liquid crystal molecules. In the main display area 10b, a horizontal component electric field generated by a voltage difference between the second pixel electrode 1018 and the second common electrode 10162 is used to drive the second liquid crystal molecules. That is, the main display area 10b utilizes a horizontal electric field to drive the second liquid crystal molecules. In addition, the pixel driving circuit layer 1015 of the light-transmitting area 10a is used to control a voltage difference between the first pixel electrode 1017 and the first common electrode 10161, and the pixel driving circuit layer 1015 of the main display area 10b is used to control a voltage difference between the second pixel electrode 1018 and the second common electrode 10162.

The thickness of the first liquid crystal layer 1011 is greater than the thickness of the second liquid crystal layer 1012 so that the thickness of the first liquid crystal layer 1011 in the light-transmitting area 10a is large, it enables the first liquid crystal layer 1011 to increase the brightness when the liquid crystal display panel 10 in the light-transmitting area 10a is in a fog state under a first preset condition. That is, the liquid crystal display panel of the light-transmitting area 10a has high brightness during display, so as to improve the display effect of the electronic device.

The thickness of the portion of the first substrate 1013 corresponding to the light-transmitting area 10a is smaller than the thickness of the portion of the first substrate 1013 corresponding to the main display area 10b, and/or the thickness of the portion of the transparent protective layer 1020 corresponding to the light-transmitting area 10a is smaller than the thickness of the portion of the transparent protective layer 1020 corresponding to the main display area 10b, and/or the thickness of the portion of the color film layer 1019 corresponding to the light-transmitting area 10a is smaller than the thickness of the portion of the color film layer 1019 corresponding to the main display area 10b.

Specifically, as shown in FIG. 4B, the thickness of the portion of the first substrate 1013 corresponding to the light-transmitting area 10a is smaller than the thickness of the portion of the first substrate 1013 corresponding to the main display area 10b. The thickness of the portion of the transparent protective layer 1020 corresponding to the light-transmitting area 10a is smaller than the thickness of the portion of the transparent protective layer 1020 corresponding to the main display area 10b. In addition, the thickness of the portion of the color film layer 1019 corresponding to the light-transmitting area 10a is smaller than the thickness of the portion of the color film layer 1019 corresponding to the main display area 10b to increase the thickness of the first liquid crystal layer 1011, thereby the light scattering effect of the first liquid crystal layer 1011 (scattering-type liquid crystal) on the liquid crystal display panel 10 of the light-transmitting area 10a is improved when displaying, and the brightness of the liquid crystal display panel 10 in the light-transmitting area 10a is improved. Moreover, the thickness of the portion of the color film layer 1019 corresponding to the light-transmitting area 10a is smaller than the thickness of the portion of the color film layer 1019 corresponding to the main display area 10b to increase the thickness of the first liquid crystal layer 1011 and also improve the light transmittance of the light-transmitting area 10a.

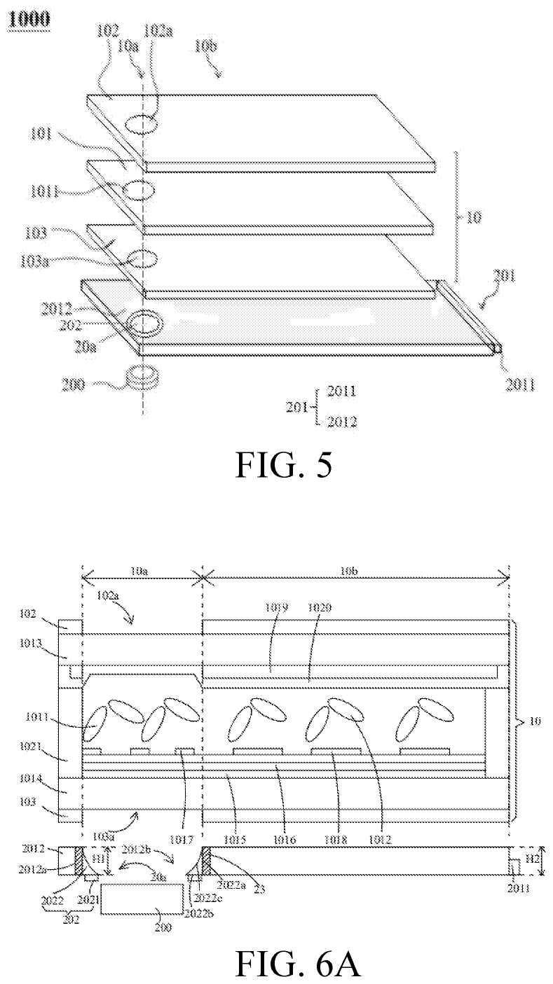

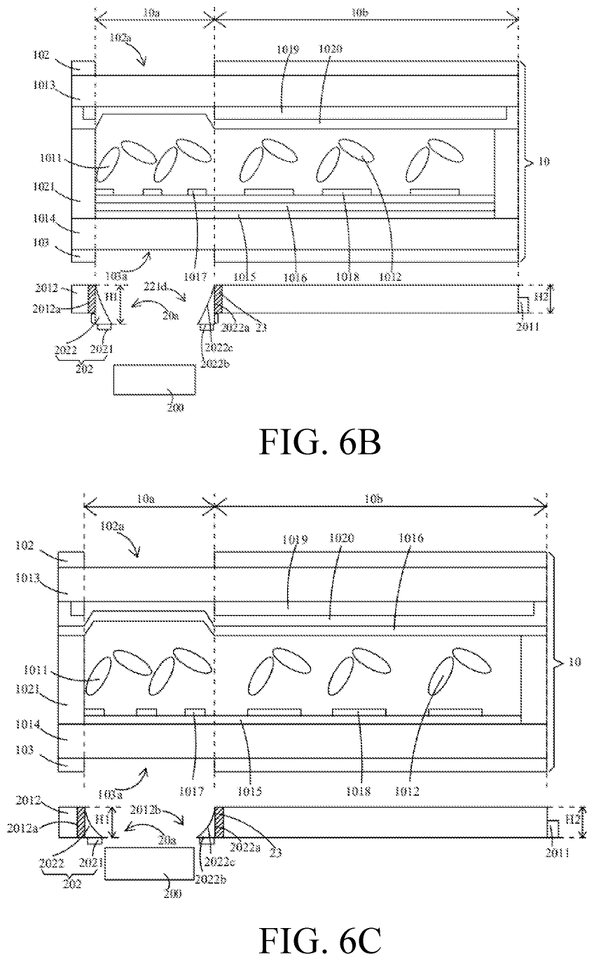

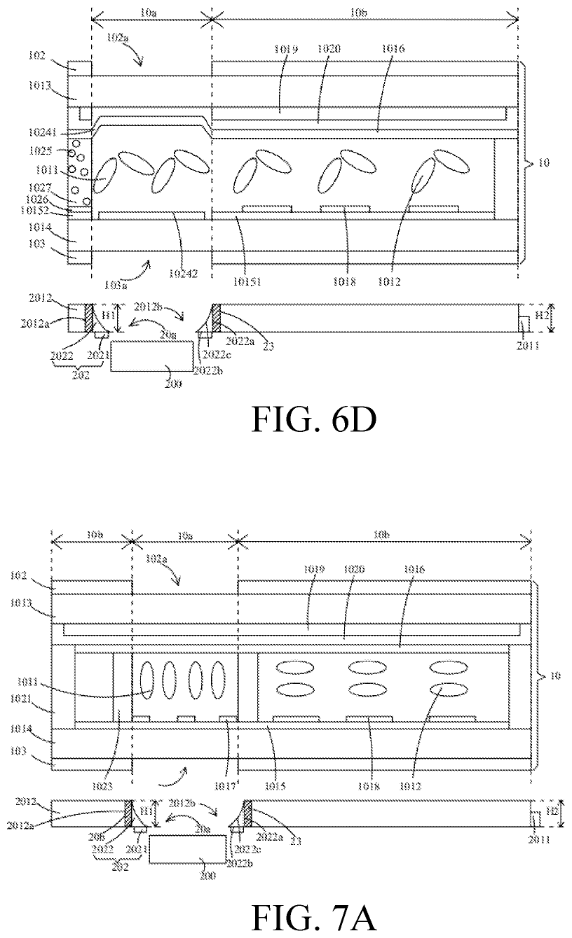

Please refer to FIG. 5 and FIG. 6A. FIG. 5 is an exploded schematic view of an electronic device according to a second embodiment of the present application, and FIG. 6A is a first schematic cross-sectional view of the electronic device shown in FIG. 5. The electronic device shown in FIG. 5 is basically similar to the electronic device shown in FIG. 2 except that the electronic device 1000 shown in FIG. 5 includes a backlight assembly 20, the backlight assembly 20 includes a first backlight assembly 201 and a second backlight assembly 202. The first backlight assembly 201 is configured to provide a backlight source for the main display area 10b, and the second backlight assembly 202 is configured to provide a backlight source for the light-transmitting area 10a. The color film layer 1019 is disposed on a surface of the first substrate 1013 toward the second substrate 1014 and is positioned outside the light-transmitting area 10a and inside the main display area 10b. That is, no color film layer 1019 is provided in the light-transmitting area 10a to improve the light transmittance of the light-transmitting area 10a when the photosensitive unit 200 is working.

As shown in FIG. 6A, the first backlight assembly 201 includes a backlight plate 2012 and a first light source 2011. The first light source 2011 is disposed on a side of the backlight plate 2012. The first light source 2011 is a white light-emitting diode (LED). The backlight plate 2012 is provided with a fourth through-hole 2012b corresponding to the light-transmitting area 10a, and the fourth through-hole 2012b is larger than the size of the light-transmitting area 10a. The first surface 2012a of the backlight plate 2012 surrounds to form the fourth through-hole 2012b, and the first surface 2012a is a vertical plane. The first liquid crystal molecules and the second liquid crystal molecules are the same, and both the first liquid crystal molecules and the second liquid crystal molecules are phase liquid crystals.

The second backlight assembly 202 includes a light-guiding ring 2022 and a second light source 2021. The second light source 2021 includes a red LED, a blue LED, and a green LED. The light-guiding ring 2022 is disposed in the light-transmitting area 10a and is positioned in the fourth through-hole 2012b. The light-guiding ring 2022 includes a first plane 2022a, a second plane 2022b, and an indented arc surface 2022c, the indented arc surface 2022c connects the first plane 2022a and the second plane 2022b, and the first plane 2022a and the second plane 2022b are perpendicular to each other. The indented arc surface 2022c surrounds to form the third through-hole 20a.

A light shielding portion 23 is provided between the light-guiding ring 2022 and the backlight plate 2012. The light shielding portion 23 is used to prevent crosstalk between the light in the backlight plate 2012 and the light in the light-guiding ring 2022, and thereby the independence between the backlight source in the light-transmitting area 10a and the backlight source in the main display area 10b is maintained. The light shielding portion 23 is provided between the first surface 2012a of the backlight plate 2012 and the first plane 2022a of the light-guiding ring 2022. The light shielding portion 23 is a reflective layer, which reflects the light in the light-guiding ring 2022 to the light-transmitting area 10a, and reflects the light in the backlight plate 2012 to the main display area 10b. The light shielding portion 23 has a ring shape.

The height H1 of the light-guiding ring 2022 can be equal to the height H2 of the backlight plate 2012. In this situation, the second light source 2021 is concentratedly disposed on the second plane 2022b of the light-guiding ring 2022.

In the light-transmitting area 10a, the first liquid crystal molecules are deflected by the horizontal electric field generated by the voltage difference between the first pixel electrode 1017 and the common electrode 1016 of the light-transmitting area 10a to process the light emitted from the second backlight assembly 202, thereby the display and light transmission of the light-transmitting area 10a are realized. In the main display area 10b, the second liquid crystal molecules are deflected by a horizontal electric field generated by a voltage difference between the second pixel electrode 1018 and the common electrode of the main display area 10b and cooperate with the selective transmission of light of the first polarizer 102 and the second polarizer 103 and the filtering effect of the color film layer 1019 to process the light emitted by the first backlight assembly 201 to realize the display and non-display of the main display area 10b.

It should be noted that the second light source 2021 outputs a driving signal from a separate IC chip to control the working states of the red LED, the blue LED, and the green LED to control the liquid crystal display panel 10 of the light-transmitting area 10a to display different RGB colors and intensity. The driving signal output by the IC chip needs to be set according to the image to be displayed in the main display area 10b to achieve 100% full-screen display in cooperation with the main display area 10b. The color film layer 1019 is disposed on a surface of the first substrate 1013 toward the second substrate 1014 and is positioned outside the light-transmitting area 10a and inside the main display area 10b.

Shown in FIG. 6B is a second schematic cross-sectional view of the electronic device shown in FIG. 5. The electronic device shown in FIG. 6B is basically similar to the electronic device shown in FIG. 6A, except that the height H1 of the light-guiding ring 2022 is greater than the height H2 of the backlight plate 2012. In this situation, the second light source 2021 can be disposed on either the second plane 2022b of the light-guiding ring 2022 or the first plane 2022a of the light-guiding ring 2022, the space for setting the second light source 2021 is increased, which is more conducive to controlling the screen display of the light-transmitting area 10a.

Please refer to FIG. 6C, which is a third schematic cross-sectional view of the electronic device shown in FIG. 5. The electronic device shown in FIG. 6C is basically similar to the electronic device shown in FIG. 6A, except that the first pixel electrode 1017 is disposed on the pixel driving circuit layer 1015 of the light-transmitting area 10a, and the common electrode 1016 is disposed on a surface of the transparent protective layer 1020 toward the second substrate 1014, and the second pixel electrode 1018 is disposed on the pixel driving circuit layer 1015 of the main display area 10b.

The plurality of first liquid crystal molecules process the light emitted from the second backlight assembly 202 under a vertical electric field generated by a voltage difference between the first pixel electrode 1017 and the common electrode 1016 of the light-transmitting area 10a to realize the liquid crystal display panel 10 in the light-transmitting area 10a can be switched between the transparent state and the image display state. The plurality of second liquid crystal molecules are subjected to a vertical electric field generated by a voltage difference between the second-pixel electrode 1018 and the common electrode 1016 of the main display area 10b, and corporate with the selective transmission of light with the first polarizer 102 and the second polarizer 103 and the selective transmission of light by the color film layer 1019 to realize the screen display of the main display area 10b.

Please refer to FIG. 6D, which is a fourth schematic cross-sectional view of the electronic device shown in FIG. 5. The electronic device shown in FIG. 6D is basically similar to the electronic device shown in FIG. 6C, except that the liquid crystal display panel 10 further includes a transparent driving circuit disposed in the light-transmitting area 10a. The transparent driving circuit is configured to drive a plurality of first liquid crystal molecules in the first liquid crystal layer 1011 to deflect.

The transparent driving circuit includes a first transparent electrode 10241 and a second transparent electrode 10242. The first transparent electrode 10241 is disposed on a surface of the first substrate 1013 toward the second substrate 1014 and is formed on the entire light-transmitting area 10a. The second transparent electrode 10242 is disposed on a surface of the second substrate 1014 toward the first substrate 1013 and is formed on the entire light-transmitting area 10a. The first transparent electrode 10241 and the second transparent electrode 10242 are oppositely disposed. Forming the first transparent electrode 10241 and the second transparent electrode 10242 without cutting on the entire surface of the light-transmitting area 10a to distinguish it from the plurality of block-shaped second pixel electrodes 1018 in the main display area 10b. Because the first transparent electrode 10241 and the second transparent electrode 10242 have seamless patterns on their entire surfaces, the influence of the optical diffraction fringes of external ambient light on the lighting effect of the photosensitive unit 200 is reduced. In addition, by providing a transparent driving circuit in the light-transmitting area 10a and remove the pixel driving circuit layer of the light-transmitting area 10a, the light reflection of the metal layer in the pixel driving circuit layer is reduced, the light transmittance of the light-transmitting area 10a is improved, the optical diffraction fringes caused by the wires in the pixel driving circuit layer are eliminated, and the efficiency of receiving the optical signal by the photosensitive unit 200 is further improved. The structure design of the light-transmitting area 10a adopts the transparent driving circuit to drive the first liquid crystal molecules, which can not only achieve the purpose of displaying a simple image but also avoid the low transparency of the display area caused by the repeated pixel structure, and avoid the scattering phenomenon when the light passes through the light-transmitting area 10a in a case of the photosensitive unit 200 is a camera, and avoid the problem of blurred or abnormal pictures taken by the camera. The first transparent electrode 10241 is formed in the same process as the common electrode 1016 of the main display area 10b and is disposed on the same layer as the common electrode 1016 of the main display area 10b. The first transparent electrode 10241 is electrically connected to the common electrode 1016. The common electrode 1016 is disposed on the surface of the transparent protective layer 1020 of the main display area 10b close to the second substrate 1014.

The liquid crystal display panel 10 further includes a second pixel driving circuit layer 10152 disposed on the second substrate 1014 and positioned at a periphery of the light-transmitting area 10a. The first transparent electrode 10241 and the second pixel driving circuit layer 10152 are electrically connected through a conductive portion. A common reference voltage is applied to the first transparent electrode 10241 and the common electrode 1016 through the conductive portion, and the second transparent electrode 10242 cooperates with a pixel driving circuit on the second substrate 1014 and obtains a driving timing signal through a gate driving circuit (Gate On Array), and a driving voltage is generated between the first transparent electrode 10241 and the second transparent electrode 10142 to control the deflected states of the plurality of first liquid crystal molecules in the first liquid crystal layer 1011, thereby realizing switching between the transparent state and the display screen. The second pixel driving circuit layer 10152 and the first pixel driving circuit layer 10151 of the main display area 10b are formed by the same process and in the same layer. The second pixel driving circuit layer 10152 is disposed on the second substrate 1014 and is positioned at a periphery of the light-transmitting area 10a.

The conductive portion includes a conductive layer 1026 and a conductive sealant 1027. The conductive layer 1026 is disposed on the second pixel driving circuit layer 10152. The conductive sealant 1027 includes adhesive and conductive microspheres 1025 filled in the adhesive. The conductive sealant 1027 is disposed between the conductive layer 1026 and the first transparent electrode 10241 extending from the light-transmitting area 10a. When the light-transmitting area 10a is close to a peripheral edge of the electronic device 1000, the adhesive is a part of the peripheral sealant 1021. The conductive layer 1026 is a transparent conductive layer. The conductive layer 1026 is electrically connected to a common voltage trace of the second pixel driving circuit layer 10152 to input a common voltage reference signal to the conductive sealant 1027. The conductive sealant 1027 inputs the common voltage reference signal to the first transparent electrode 10241. When the light-transmitting area 10a is disposed away from the peripheral edge of the electronic device, the conductive sealant 1027 is an adhesive independent of the peripheral sealant 1021.

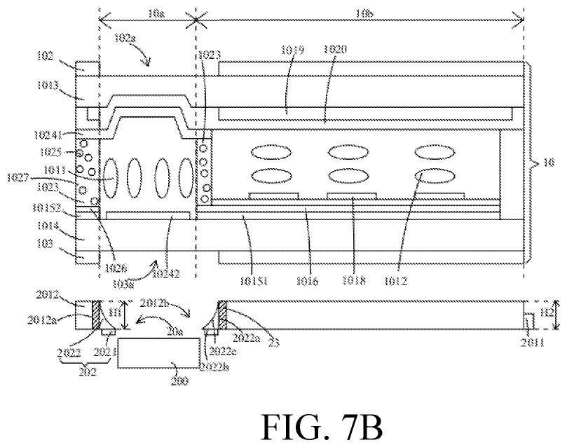

Please refer to FIG. 7A, which is a fifth schematic cross-sectional view of the electronic device shown in FIG. 5. The electronic device shown in FIG. 7A is basically similar to the electronic device shown in FIG. 6C. The difference is that the first liquid crystal molecules are different from the second liquid crystal molecules. The first liquid crystal molecules are scattering-type liquid crystals and the second liquid crystal molecules are one of thermotropic liquid crystals, lyotropic liquid crystals, and phase liquid crystals. An isolation portion 1023 is provided between the first liquid crystal layer 1011 and the second liquid crystal layer 1012. The isolation portion 1023 is independent of the peripheral sealant 1021, and the isolation portion 1023 is an annular sealant.

Please refer to FIG. 7B, which is a sixth cross-sectional view of the electronic device shown in FIG. 5. The electronic device shown in FIG. 7B is basically similar to the electronic device shown in FIG. 6A except that the first liquid crystal molecules are different from the second liquid crystal molecules, the first liquid crystal molecules are scattering-type liquid crystals and the second liquid crystal molecules are one of thermotropic liquid crystals, lyotropic liquid crystals, and phase liquid crystals. The light-transmitting area 10a further includes a transparent driving circuit for driving a plurality of first liquid crystal molecules in the first liquid crystal layer 1011 to deflect. The pixel electrode 1018 and the common electrode 1016 of the main display area 10b in FIG. 7B are the same as the pixel electrode 1018 and the common electrode 1016 of the main display area 10b in FIG. 6A, and will not be described in detail here.

The transparent driving circuit includes a first transparent electrode 10241 and a second transparent electrode 10242. The first transparent electrode 10241 is disposed on a surface of the first substrate 1013 toward the second substrate 1014 and is formed on the entire light-transmitting area 10a. The second transparent electrode 10242 is disposed on a surface of the second substrate 1014 toward the first substrate 1013 and is formed on the entire light-transmitting area 10a. Forming the first transparent electrode 10241 and the second transparent electrode 10242 without cutting on the entire surface of the light-transmitting area 10a to distinguish it from the second pixel electrodes 1018 in the main display area 10b. Because the first transparent electrode 10241 and the second transparent electrode 10242 have seamless patterns on their entire surfaces, the influence of the optical diffraction fringes of external ambient light on the lighting effect of the photosensitive unit 200 is reduced. In addition, by providing a transparent driving circuit in the light-transmitting area 10a and remove the pixel driving circuit layer of the light-transmitting area 10a, the light reflection of the metal layer in the pixel driving circuit layer is reduced, the light transmittance of the light-transmitting area 10a is improved, the optical diffraction fringes caused by the wires in the pixel driving circuit layer are eliminated, and the efficiency of receiving the optical signal by the photosensitive unit 200 is further improved.

The liquid crystal display panel 10 further includes a second pixel driving circuit layer 10152 disposed on the second substrate 1014 and positioned at a periphery of the light-transmitting area 10a. The first transparent electrode 10241 and the second pixel driving circuit layer 10152 are electrically connected through a conductive portion. A common reference voltage is applied to the first transparent electrode 10241 through the conductive portion, and the second transparent electrode 10242 cooperates with a pixel driving circuit on the second substrate 1014 and obtains a driving timing signal through a gate driving circuit (Gate On Array), and a driving voltage is generated between the first transparent electrode 10241 and the second transparent electrode 10142 to control the deflected states of the plurality of first liquid crystal molecules in the first liquid crystal layer 1011, thereby realizing switching between the transparent state and the display screen. The second pixel driving circuit layer 10152 and the first pixel driving circuit layer 10151 of the main display area 10b are formed by the same process.

The conductive portion includes a conductive layer 1026 and a conductive sealant 1027. The conductive layer 1026 is disposed on the second pixel driving circuit layer 10152. The conductive sealant 1027 includes isolation portion 1023 and conductive microspheres 1025 filled in the isolation portion 1023. The conductive sealant 1027 is disposed between the conductive layer 1026 and the first transparent electrode 10241 extending from the light-transmitting area 10a. The isolation portion is an annular sealant. When the light-transmitting area 10a is close to a peripheral edge of the electronic device 1000, the isolation portion 1023 partially coincides with the peripheral sealant 1021. The conductive layer 1026 is a transparent conductive layer. The conductive layer 1026 is electrically connected to a common voltage trace of the second pixel driving circuit layer 10152 to input a common voltage reference signal to the conductive sealant 1027. The conductive sealant 1027 inputs the common voltage reference signal to the first transparent electrode 10241.

Further, a thickness of a portion of the first substrate 1013 corresponding to the light-transmitting area 10a is smaller than a thickness of a portion of the first substrate 1013 corresponding to the main display area 10b, and a thickness of a portion of the transparent protective layer 1020 corresponding to the light-transmitting area 10a is smaller than a thickness of a portion of the transparent protective layer 1020 corresponding to the main display area 10b, thereby a thickness of the first liquid crystal layer 1011 is increased and the brightness of the liquid crystal display panel 10 of the light-transmitting area 10a during displaying is enhanced.

As described above, in FIG. 3A, FIG. 3C, and FIG. 3D, the first liquid crystal molecules and the second liquid crystal molecules are the same, and the first liquid crystal molecules and the second liquid crystal molecules are phase liquid crystals and the light-transmitting areas 10a in FIG. 3A, FIG. 3C, and FIG. 3D are all provided with a color film layer. In FIG. 4A and FIG. 4B, the first liquid crystal molecules and the second liquid crystal molecules are different. The first liquid crystal molecules are scattering-type liquid crystals and the second liquid crystal molecules are selected from one of thermotropic liquid crystal, lyotropic liquid crystal, and phase liquid crystal. The light-transmitting areas 10a in FIG. 4A and FIG. 4B are both provided with a color film layer. The light-transmitting areas 10a and the main display area 10b in FIG. 3A, FIG. 3C, FIG. 3D, FIG. 4A, and FIG. 4B all use the first backlight assembly 201 as their backlight source, and the light-transmitting area 10a does not need to be provided with a backlight source separately. In FIG. 6A, FIG. 6B, FIG. 6C, and FIG. 6D, the first liquid crystal molecules are the same as the second liquid crystal molecules, and the first liquid crystal molecules and the second liquid crystal molecules are phase liquid crystals. The light-transmitting areas 10a in FIG. 6A-FIG. 6D are not provided with a color film layer to increase the light transmittance of the light-transmitting areas 10a when the photosensitive unit 200 is working, and to improve the lighting effect of the photosensitive unit 200.

In FIG. 7A and FIG. 7B, the first liquid crystal molecules are different from the second liquid crystal molecules. The first liquid crystal molecules are scattering-type liquid crystals, and the second liquid crystal molecules are selected from one of thermotropic liquid crystal, lyotropic liquid crystal, and phase liquid crystal. The light-transmitting areas 10a in FIG. 7A and FIG. 7B both are not provided with a color film layer. In FIG. 6A, FIG. 6B, FIG. 6C, FIG. 6D, FIG. 7A, and FIG. 7B, a second backlight assembly 202 is provided as the backlight source in the light-transmitting area 10a. The main display area 10b is provided with a first backlight assembly 201 as a backlight source, and the second backlight assembly 202 is controlled by a separate IC chip to output a driving signal, and the driving signal needs to be matched with the setting of the screen to be displayed in the main display area 10b.

The descriptions of the above embodiments are only used to understand the technical solution of the application and its core ideas. Those skilled in the art should understand that the technical solutions described in the foregoing embodiments can be modified, or some of the technical features can be equivalently replaced. These modifications or replacements do not make the essence of the corresponding technical solutions outside the scope of the technical solutions in the embodiments of the present application.

What is claimed is:

1. A liquid crystal display panel, comprising at least one light-transmitting area, wherein the liquid crystal display panel comprises a first substrate, a second substrate, a first polarizer, and a second polarizer, the first substrate and the second substrate are oppositely disposed, the first polarizer is disposed on a surface of the first substrate away from the second substrate and a first through hole is provided corresponding to the light-transmitting area, the second polarizer is disposed on a surface of the second substrate away from the first substrate and a second through-hole is provided corresponding to the light-transmitting area, a first liquid crystal layer is provided between a portion of the first substrate corresponding to the light-transmitting area and a portion of the second substrate corresponding to the light-transmitting area, the first liquid crystal layer is configured to enable a portion of the liquid crystal display panel corresponding to the light-transmitting area in a display state, and the first liquid crystal layer comprises a plurality of first liquid crystal molecules.

2. The liquid crystal display panel according to claim 1, wherein the first liquid crystal layer enables a portion of the liquid crystal display panel corresponding to the light-transmitting area in a display state under a first preset condition, the first preset condition is that a voltage difference between a portion of the first substrate corresponding to the light-transmitting area and a portion of the second substrate corresponding to the light-transmitting area is greater than or equal to a first preset threshold.

3. The liquid crystal display panel according to claim 2, wherein the plurality of the first liquid crystal molecules in the first liquid crystal layer enables a portion of the liquid crystal display panel corresponding to the light-transmitting area in a transparent state or a semi-transparent state under a second preset condition, the second preset condition is that a voltage difference between a portion of the first substrate corresponding to the light-transmitting area and a portion of the second substrate corresponding to the light-transmitting area is less than the first preset threshold.

4. The liquid crystal display panel according to claim 1, wherein the first liquid crystal molecule is a phase liquid crystal.

5. The liquid crystal display panel according to claim 4, wherein the phase liquid crystal is selected from at least one of a twisted nematic phase liquid crystal and a polymer-stabilized blue phase liquid crystal.

6. The liquid crystal display panel according to claim 1, wherein the first liquid crystal molecule is a scattering-type liquid crystal.

7. The liquid crystal display panel according to claim 1, wherein the liquid crystal display panel further comprises a main display area, the main display area is positioned at a periphery of the light-transmitting area, a second liquid crystal layer is provided between a portion of the first substrate corresponding to the main display area and a portion of the second substrate corresponding to the main display area, the second liquid crystal layer comprises a plurality of second liquid crystal molecules.

8. The liquid crystal display panel according to claim 7, wherein the first liquid crystal molecule and the second liquid crystal molecule are same.

9. The liquid crystal display panel according to claim 8, wherein the first liquid crystal molecule and the second liquid crystal molecule are both phase liquid crystal.

10. The liquid crystal display panel according to claim 7, wherein the first liquid crystal molecule and the second liquid crystal molecule are different.

11. The liquid crystal display panel according to claim 10, wherein the liquid crystal display panel further comprises an isolation portion, the isolation portion is disposed between the first liquid crystal layer and the second liquid crystal layer to isolate the first liquid crystal layer and the second liquid crystal layer, the isolation portion is positioned between the first substrate and the second substrate and is positioned at the periphery of the light-transmitting area.

12. The liquid crystal display panel according to claim 11, wherein the isolation portion is an annular sealant.

13. The liquid crystal display panel according to claim 10, wherein the first liquid crystal molecule is a scattering-type liquid crystal, and the second liquid crystal molecule is selected from one of a thermotropic liquid crystal, a lyotropic liquid crystal, and a phase liquid crystal.

14. The liquid crystal display panel according to claim 13, wherein a thickness of the first liquid crystal layer is greater than a thickness of the second liquid crystal layer.

15. The liquid crystal display panel according to claim 14, wherein the liquid crystal display panel further comprises a transparent protective layer formed on a surface of the first substrate toward the second substrate, a thickness of a portion of the first substrate corresponding to the light-transmitting area is less than a thickness of a portion of the first substrate corresponding to the main display area, and/or a thickness of a portion of the transparent protective layer corresponding to the light-transmitting area is less than a thickness of a portion of the transparent protective layer corresponding to the main display area.

16. The liquid crystal display panel according to claim 1, wherein the liquid crystal display panel further comprises a transparent driving circuit disposed in the light-transmitting area, the transparent driving circuit is configured to drive the plurality of the first liquid crystal molecule in the first liquid crystal layer to deflect.

17. The liquid crystal display panel according to claim 16, wherein the transparent driving circuit comprises a first transparent electrode and a second transparent electrode, the first transparent electrode is disposed on a surface of the first substrate toward the second substrate and is formed on an entirety of the light-transmitting area, and the second transparent electrode is disposed on a surface of the second substrate toward the first substrate and is formed on an entirety of the light-transmitting area.

18. The liquid crystal display panel according to claim 17, wherein the liquid crystal display panel further comprises a second pixel driving circuit layer disposed on the second substrate and positioned at a periphery of the light-transmitting area, and the first transparent electrode and the second pixel driving circuit layer are electrically connected by a conductive portion.

19. A liquid crystal display device, comprising the liquid crystal display panel of claim 1 and a backlight assembly, wherein the backlight assembly is positioned at a side of the liquid crystal display panel where the second substrate is positioned, and the backlight assembly corresponding to the light-transmitting area of the liquid crystal display panel is provided with a third through-hole.

20. An electronic device, comprising the liquid crystal display device of claim 19 and a photosensitive unit, wherein the photosensitive unit is disposed opposite to a side of the liquid crystal display device where light is emitted and is disposed corresponding to the light-transmitting area.
